(19) United States
(12) Patent Application Publication
(10) Pub. No.: US 2011/0088469 A1
(43) Pub. Date: Apr. 21, 2011

(54) ROTATION-RATE SENSOR HAVING TWO SENSITIVE AXES

(76) Inventors: Reinhard Neul, Stuttgart (DE); Johannes Classen, Reutlingen (DE); Sebastian Gracki, Reutlingen (DE); Burkhard Kuhlmann, Reutlingen (DE); Axel Franke, Ditzingen (DE); Oliver Kohn, Reutlingen (DE); Kersten Kehr, Zwota (DE); Christian Gerhardt, Reutlingen (DE)

(21) Appl. No.: 12/513,834

(22) PCT Filed: Nov. 8, 2007
(86) PCT No.: PCT/EP07/62073

§ 371 Date: Jan. 5, 2011

(51) Int. Cl. G01C 19/56

(52) U.S. Cl. 73/504.12

(57) ABSTRACT

A method and system are provided including a rotation-rate sensor having a substrate, a bearing, a vibrating structure suspended on the bearing by springs in a rotatable manner for performing a planar driving vibration motion, and drive means for producing the planar driving vibration motion of the vibrating structure. The rotation-rate sensor has first evaluation means for detecting a rotation in a first axis of rotation and second evaluation means for detecting a rotation in a second axis of rotation.

### FIELD OF THE INVENTION

The present invention relates to a rotation-rate sensor having a substrate, a bearing, a vibrating structure suspended on the bearing by springs in a rotatable manner for performing a planar driving vibration motion and drive means for producing the planar driving vibration motion of the vibrating structure.

### BACKGROUND INFORMATION

Micromechanical rotation-rate sensors having one sensing axis (sensitive axis) are used for the most diverse applications.

In a motor vehicle, for example, these are the anti-skidding program ESP, navigation and rollover measurement, while in home electronics there are applications in the area of image stabilization, motion detection and navigation.

German Document No. DE 195 23 895 A1 appears to describe a micromechanical rotation-rate sensor having one sensing axis, in which a rotor mass suspended centrally via cantilever springs is excited to undergo rotary vibrations and experiences a tilting when a rotation rate occurs due to the Coriolis effect. This deflection is detected by electrodes that are placed in a conductive layer above a substrate.

An increasing number of applications, e.g., the image stabilization in digital cameras, requires multiaxial rotation-rate sensors. For such purposes, multiple single-channel sensors are hitherto generally situated side-by-side or—depending on the required combination of sensitive axes of rotation—are even installed over printed circuit boards stood on edge.

The use of two separate single-channel rotation-rate sensors has disadvantages with respect to costs, space requirement, power requirement and the relative precision of orientation of the two axes.

### SUMMARY

Embodiments of the present invention include a rotation-rate sensor having a substrate, a bearing, a vibrating structure suspended on the bearing by springs in a rotatable manner for performing a planar driving vibration motion, and drive means for producing the planar driving vibration motion of the vibrating structure. In an embodiment, the rotation-rate sensor has first evaluation means for detecting a rotation in a first axis of rotation and second evaluation means for detecting a rotation in a second axis of rotation.

Advantageously, an embodiment of the present invention creates a rotary rotation-rate sensor having two sensitive axes. This makes it possible to evaluate two measuring axes simultaneously on a single chip. The sensor is sensitive to both axes of rotation x, y in the plane of the chip.

This yields additional advantages. In an embodiment, the sensor core is only insignificantly larger than a single-channel sensor having comparable specification requirements. In an embodiment, the power requirement is significantly lower than for two single-channel sensors. On the one hand, only a single drive circuit is required for both measuring axes, while on the other hand, in particular, e.g., when using digital evaluation circuits, larger functional blocks of the circuit may be used jointly by both detection channels via timed multiplexing. The precise micromechanical manufacture of the component, in combination with the highly symmetrical sensor design, ensures a well-matched performance and sensitivity of the two measuring channels. In addition, in an embodiment, the relative orientation of the two measuring axes is given by design and is not impaired by tolerances in the packaging of integrated circuits as in the installation of two single-channel sensors.

### BRIEF DESCRIPTION OF THE DRAWINGS

FIG. 1 shows a micromechanical functional part of a rotation-rate sensor according to the related art.

FIG. 2 shows a top-view schematic representation of the micromechanical functional part of a rotation-rate sensor as shown in FIG. 1.

FIG. 3 shows a rotation-rate sensor according to an embodiment of the present invention having two sensitive axes.

FIG. 4A shows a specific embodiment of the suspension structure of a rotation-rate sensor according to an embodiment of the present invention.

FIG. 4B shows a specific embodiment of the suspension structure of a rotation-rate sensor according to an embodiment of the present invention.

FIG. 5 shows a rotation-rate sensor according to an embodiment of the present invention having self-test electrodes.

FIG. 6 shows a rotation-rate sensor according to an embodiment of the present invention having enlarged drive means.

### DETAILED DESCRIPTION

Exemplary embodiments of the present invention are shown by way of example in the Figures and are described below.

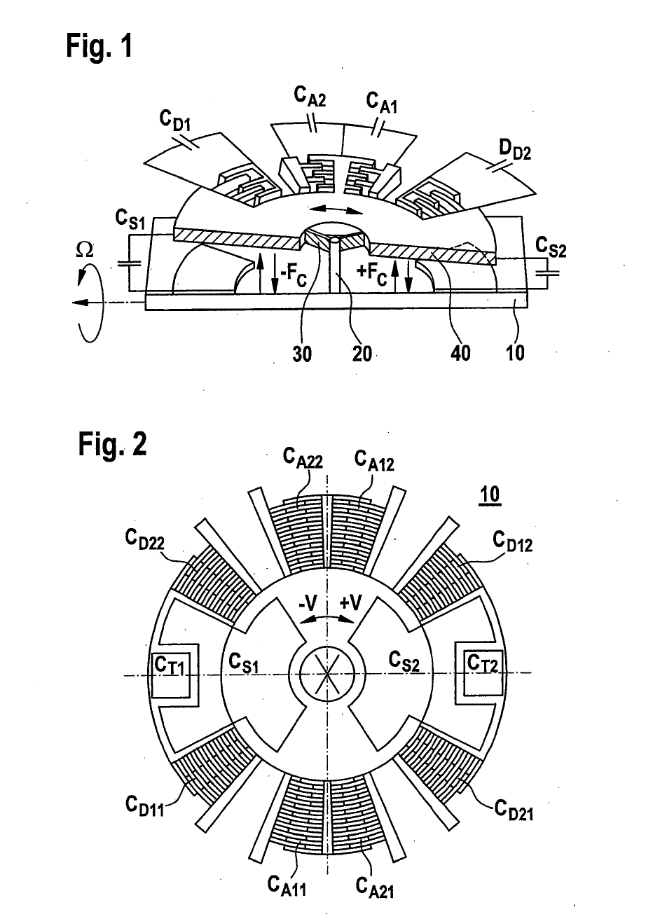

FIG. 1 shows the micromechanical functional part of a rotation-rate sensor according to the related art. The rotation-rate sensor is shown in a schematic sectional view. The figure shows a substrate or support 10, a hub 20 having suspension springs or vibrating springs 30 and a vibrating mass 40. Hub 20 is connected to support 10. Via vibrating springs 30, the hub is also connected to vibrating mass 40. The rotation-rate sensor has drive means in the form of comb structures C_{A1}, C_{A2}, which drive vibration V. The seismic mass or vibrating mass 40 capable of being excited to vibrate is driven by the fact that the two combs of a drive structure such as C_{A1}, for example, represent two electrodes that are charged to different electrical potentials. The complementary combs are drawn into each other as a result of the electrostatic force of attraction, and vibrating mass 40 is thereby deflected. Furthermore, the rotation-rate sensor has comb structures C_{D1}, C_{D2}, which are suited to detect the amplitude of the drive vibration and whose signal is generally used for regulating this amplitude. The rotation-rate sensor has detection means in the form of capacitor structures C_{S1}, C_{S2}, which are used for measuring the deflection of the vibration mass resulting from an acting Coriolis force F_{C}.

During the operation of the rotation-rate sensor, vibrating mass 40 vibrates on a spherical path V around hub 20. As intended, the rotation-rate sensor detects rotations about the sensitive axis, the axis of rotation Ω. In such a rotation of the sensor around Ω, Coriolis forces F_{C} occur by law of nature, which result in a deflection of vibrating mass 40 in the direction indicated by arrows perpendicular to the plane of vibration. The sense of direction of Coriolis forces F_{C} changes respectively with the sense of direction of rotary vibration V of vibrating mass 40.

FIG. 2 shows the schematic representation of the micromechanical functional part of a rotation-rate sensor as shown in FIG. 1 in the top view. Drive combs C_{A11}, C_{A12}, C_{A21}/C_{A22} and detection combs C_{D11}, C_{D12}, C_{D21}, C_{D22} are shown. Drive combs C_{A11}, C_{A12} are used for driving vibrating mass 40 in the direction +V. Drive combs C_{A21}, C_{A22} are used for driving vibrating mass 40 in the direction −V. Detection combs CD₁₁, CD₁₂, CD₂₁, CD₂₂ are used for measuring the amplitude of the drive deflection in the two directions +V and −V. The capacity of these capacitor-like comb structures C_{D11}, C_{D12} C_{D21} C_{D22} depends on the depth to which the combs are inserted into each other and thus on the overlap surface of the capacitor plates with respect to each other. Electrodes CT1 and CT2 represent test electrodes. Applying a voltage to test electrodes CT1 and CT2 achieves a deflection of vibrating mass 40 in the direction of Coriolis forces F_{C}. Thus the effect of Coriolis forces F_{C} may be simulated and the deflectability of vibrating mass 40 may be tested. This makes it possible to test the functionality of the sensor.

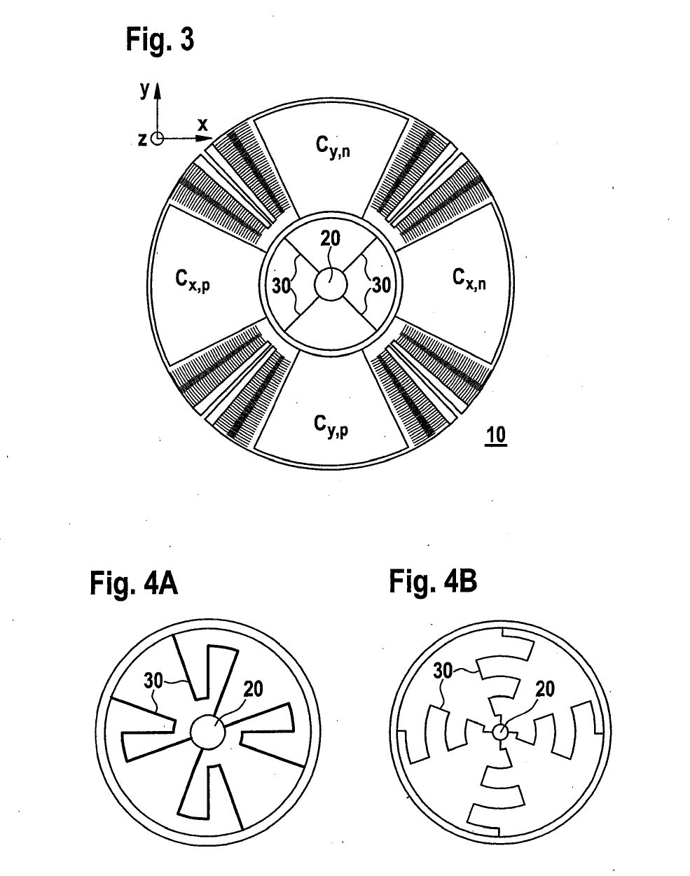

FIG. 3 shows a rotation-rate sensor according to an embodiment of the present invention having two sensitive axes. The rotation-rate sensor according to the present invention is developed from the above-described rotation-rate sensor in the related art. The dual-channel (because equipped with two sensitive axes) rotation-rate sensor may be manufactured in the same surface-micromechanical process. While the single-channel rotation-rate sensor in the related art exhibits a great asymmetry in the spring stiffnesses and moments of inertia of the suspension structure having springs 30 with respect to the x axis and the y axis, the design of the dual-channel structure is highly symmetrical with respect to these two axes. Rotor 40 is connected to substrate 10 via springs 30 that lead centrally toward the interior and are suspended near the center from a hub 20. The structure is set in rotation about the vertical axis (z axis) via drive combs. Drive detection combs measure the deflection of the system and supply the signal to a control circuit, which is able to operate the sensor in a stable manner at its drive frequency. When a rate of rotation occurs about the x axis, a rotation of the rotor about the y axis is brought about as a result of the Coriolis effect. Conversely, if a rate of rotation occurs about the y axis, this results in a rotation of the rotor about the x axis. Below the four “rotor arms”, i.e. springs 30, on the buried circuit trace level of a substrate 10, there are detection means in the form of structured electrode surfaces that detect the tilting of the rotor via the resulting capacity changes. The rates of rotation about the x and y axes may be derived respectively from the differential signals Cx,p-Cx,n and Cy,p-Cy,n of the respectively opposite electrodes of first detection means and second detection means. For example, in an ideal symmetrical structure, a rate of rotation about the x axis does not result in a signal in the y channel and vice versa.

FIGS. 4 A and B show two specific embodiments of the suspension structure of a rotation-rate sensor according to the present invention. The precise location of the natural frequencies in the drive and detection motion has substantial influence, among other things, on the sensitivity and the power consumption of the sensor. The spring geometry is thus designed accordingly in order to achieve the desired frequencies. For this purpose, it is generally not sufficient to use simple cantilever springs, as are shown schematically in FIG. 2. Rather, springs 30 will have more complicated geometries. These may be, for example, springs designed in meander form, as shown in FIGS. 4A and 4B. The number of springs 30 may vary as well, but will for reasons of symmetry advantageously amount to a multiple of four. On the other hand, more than eight springs are hardly practical since they require too much space and the resulting spring stiffness would be too high for most applications.

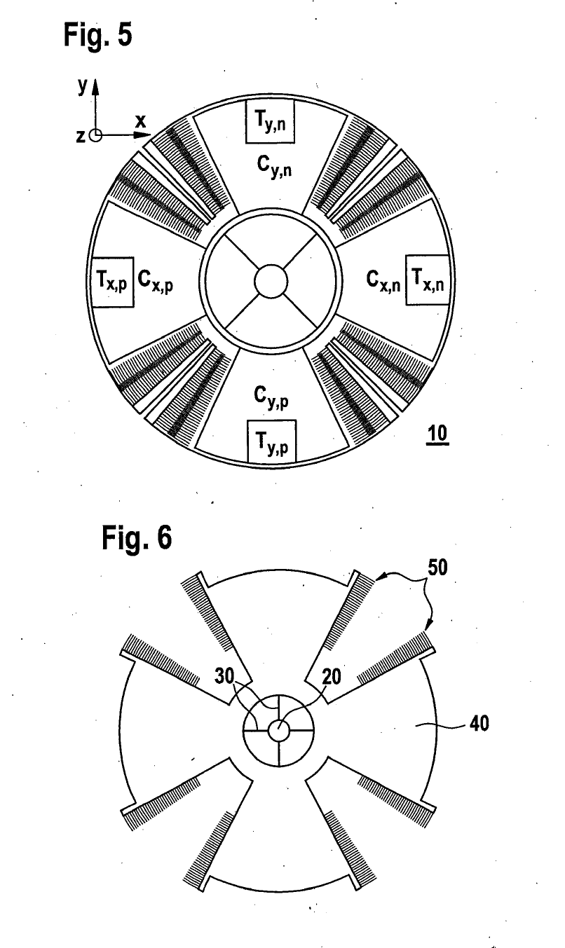

FIG. 5 shows a rotation-rate sensor according to an embodiment of the present invention having self-test electrodes. As shown, a partial area of detection electrodes Cx,i and Cy,i (i=p,n) on substrate 10 may be spared and used for separately contactable test electrodes Tx,i and Ty,i (i=p,n). Electrical forces may be introduced via these test electrodes and the resulting tilt of sensor element 40 may be measured, in analogy to the tilt resulting from a rate of rotation, via the normal detection electrodes Cx,i and Cy,i (i=p,n). Thus the sensor is able to perform a simple self-test.

FIG. 6 shows a rotation-rate sensor according to an embodiment of the present invention having enlarged drive means. In order to enlarge the drive amplitude or to reduce the required drive voltage (and thus the power consumption) compared to the specific embodiments in the related art, an increase of the drive capacity by additional drive combs may be desirable. The micromechanical rotation-rate sensors described here are manufactured cost-effectively by surface micromechanical process. For this purpose, following processing, a semiconductor substrate having many sensors is cut up into rectangular pieces, each of which support one sensor element. An embodiment of the present invention now provides for the drive electrode combs to extend essentially along the diagonals of rectangular substrate 10. Since the electrodes extend in the diagonals of the chip, it is possible to lengthen the drive electrode combs beyond the actual rotor radius and thus to implement a greater number of drive combs or drive detection combs without enlarging the rectangular chip surface. Since, in an embodiment of the present invention, especially the outer combs are particularly efficient in generating the drive torque, a small increase in the number of combs is very advantageous.

1-7. (canceled)

8. A rotation-rate sensor, comprising:
a substrate;
a bearing;
a vibrating structure suspended on the bearing by springs in a rotatable manner for performing a planar driving vibration motion; and
drive means for producing the planar driving vibration motion of the vibrating structure,
wherein the rotation-rate sensor has first evaluation means for detecting a rotation in a first axis of rotation and second evaluation means for detecting a rotation in a second axis of rotation.

9. The rotation-rate sensor as recited in claim 8, wherein the vibrating structure is suspended above a substrate having a principal plane of extension (x, y) and performs a driving vibration motion about the vertical z axis.

10. The rotation-rate sensor as recited in claim 8, wherein the two axes of rotation are in the substrate plane.

11. The rotation-rate sensor as recited in 10, wherein the first axis of rotation corresponds to the x axis and the second axis of rotation corresponds to the y axis.

12. The rotation-rate sensor as recited in claim 8, wherein the vibrating structure has a first maximum extension from the bearing to its outer edge and the drive means have a second maximum extension from the bearing to their outer edge, the second maximum extension being greater than the first maximum extension.

13. The rotation-rate sensor as recited in claim 8, wherein one of four and an integral multiple of four springs is provided.

14. The rotation-rate sensor as recited in claim 8, wherein the springs are developed to be repeatedly folded, in particular in a meander form.
